(19) United States
(12) Patent Application Publication
(10) Pub. No.: US 2022/0316889 A1
(43) Pub. Date: Oct. 6, 2022

(54) SYSTEM AND METHOD FOR TRIP PLANNING

(71) Applicants: Rajesh Patel, Fountain Valley, CA (US); Sudha Patel, Henderson, NV (US)

(72) Inventors: Rajesh Patel, Fountain Valley, CA (US); Sudha Patel, Henderson, NV (US)

(21) Appl. No.: 17/493,248

(22) Filed: Oct. 4, 2021

Related U.S. Application Data
(63) Continuation-in-part of application No. 17/222,748, filed on Apr. 5, 2021.

(51) Int. Cl. G01C 21/34; G01C 21/36; G06Q 10/04; G06Q 10/10; G06Q 50/16

(52) U.S. Cl. CPC G01C 21/343; G01C 21/3492; G01C 21/3602; G01C 21/3647; G06Q 10/047; G06Q 10/1095; G06Q 50/16

(57) ABSTRACT

A system and method for finding an optimum travel plan for several subsequent destinations. The system can receive several destinations from the user and determine the optimum travel plan. The different destinations can be provided by capturing an address or location from a webpage or uploading an image of the destination.

### CROSS-REFERENCE TO RELATED APPLICATIONS

This application is a continuation-in-part of a U.S. non-provisional patent application Ser. No. 17/222,748, filed on Apr. 5, 2021, which is incorporated herein by reference in its entirety.

### FIELD OF INVENTION

The present invention relates to a system and method for trip planning, and more particularly, the present invention relates to a system and method for determining an optimum travel plan for multiple subsequent destinations.

### BACKGROUND

Maps and route planning applications are known in the art. Such applications can show the different routes available to reach a destination. Moreover, the applications can receive starting and destination locations and provides turn-by-turn navigation to the destination. The startling location can be the current location as determined by the GPS unit or any location that can be manually entered.

The user willing to travel to more than one place generally plans the travel to minimize the travel time. Currently, planning is done manually in the mind, the user reaches the first destination and from there travels to the next destination. Planning the travel between different subsequent destinations can be time-consuming and hard. Moreover, a variety of factors can affect the average time to reach a place, such as traffic, road closures, alternate paths, etc. Thus, a long-term desire is there for a system and method for trip planning to multiple subsequent destinations.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a trip planning system and method to find an optimum travel plan to multiple subsequent destinations.

It is an additional object of the present invention that the optimum travel plan may require minimum travel time.

It is still an additional object of the present invention that the optimum travel plan has the shortest travel distance.

It is a further object of the present invention that the system can take other factors, such as appointment time, meeting time, or visiting duration of a destination.

It is still a further object of the present invention that the system can receive locations and additional information from different sources.

It is also an additional object of the present invention that the system may not require manual entering the different destinations.

It is still an additional object of the present invention that the system may permit near real time tracking of the location and path.

In one aspect, disclosed is a system and method for finding an optimum travel plan for multiple subsequent destinations. The system can receive multiple destination locations from one or more sources.

In one aspect, the system can manually receive a destination and add the received destination to the list of destinations.

In one aspect, the system through an interface can capture the destinations from search engines, directories, and web portals.

In one aspect, the system can retrieve the destination from an image of the destination, wherein the image includes the GPS coordinates of where the image was captured.

In one aspect, the system can show the optimum travel plan superimposed on a dynamic map. The dynamic map can show places of interest, medical facilities, diagnostic centers, and like.

In one aspect, the system may permit tracking of near-real time location and path followed, wherein the information can be shared with other users in near real time. In one case, the system may save the path taken with date and time information for later use. The system can present a saved journey including the destinations visited, path taken between the subsequent destinations with date and time information on a dynamic map. Additionally, the saved destinations can be searched using keywords related to user name, destinations, date, and like variables.

These and other objects, advantages of the embodiments herein, and summary of the invention will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a real estate listing having a link to send the listing to the disclosed system for adding to the list of destinations the user desire to visit, according to an exemplary embodiment of the present invention.

FIG. 2 shows an exemplary embodiment of a real estate listings search interface provided by the disclosed system, according to the present invention.

FIG. 3 shows an interface that can be presented on a user device for uploading an image, according to an exemplary embodiment of the present invention.

FIG. 4 is another embodiment of the interface shown in FIG. 3 for confirming the address, according to an exemplary embodiment of the present invention.

FIG. 5 shows an exemplary embodiment of the interface provided by the disclosed system for adding destinations and a travel plan superimposed on a map interface, according to an exemplary embodiment of the present invention.

FIG. 6 is a flow chart showing the method of determining an optimum travel plan, according to an exemplary embodiment of the present invention.

FIG. 7 shows another exemplary embodiment of the interface providing an option to view near-real time tracking and information of other users, according to an exemplary embodiment of the present invention.

FIG. 8 shows another exemplary embodiment of the interface showing options to start and stop tracking and directions, according to an exemplary embodiment of the present invention.

FIG. 9 is an environmental diagram showing the disclosed system in communication with a client device, according to exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for trip planning between multiple subsequent destinations. The disclosed system can find an optimum travel plan that requires lesser travel time and is shorter in travel distance. The disclosed system and method can be helpful to a person wishing to travel to multiple subsequent destinations. For example, the salespersons typically make multiple visits to different destinations. Persons looking to buy or rent a home generally visit multiple sites to enquire and experience the site before making the deal. Similarly, to buy general items, like clothing, car, and like, persons tend to visit different stores to personally experience the brands.

The disclosed system can receive a list of destinations from a user and determine an optimum travel plan. The disclosed system can consider different parameters such as travel distance, traffic, halts, and like to determine the optimum plan. The system can also receive other factors such as the appointment time of one or more of the destinations. A destination the user desire to visit may have a certain time restriction during which the user can visit the place, such as opening hours of a shop. Or a site the user wishes to check can have limited visiting hours. The disclosed system can, while processing the optimum travel plan, consider the above factors. The disclosed system through an interface can also receive additional information from the user for making the travel plan. Such additional information can include the time to spend at a particular destination. The disclosed system can consider different factors to optimize the travel route to subsequent destinations, such as the number of turns on the route. A user may not desire to have many turns but look for a straighter route.

The user can determine the possible destinations by past experiences, feedback from friends, online searching, catalogs, and like. In one case, the system can provide a plugin or app that can monitor the webpages for addresses. On finding such addresses, an option can be provided by the system, wherein the user can select the option to capture an associated address. For example, while searching for a property on a real estate website or listing or directory, the disclosed system through a plugin can look for addresses on the webpage and add an option next to each address that allows for capturing the address of the property directly. In one case, an icon can be provided next to the address, wherein the user can click on the icon to add the associated address to the list of destinations.

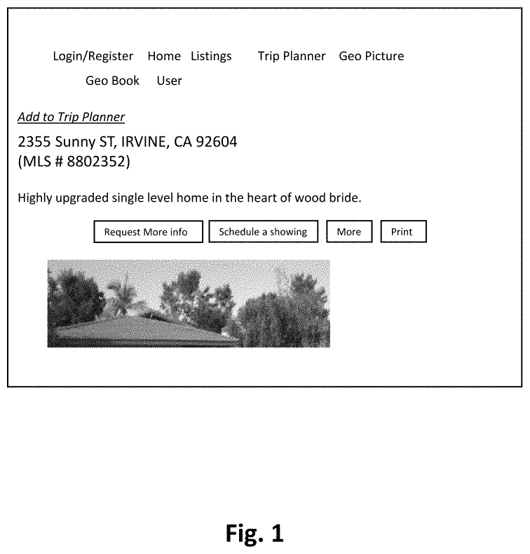

In one aspect, the websites, directories, listings, and like can add an option next to each listing, wherein clicking the option by the user adds the address of the listing to the list of destinations. Referring to FIG. 1, which shows a real estate listing with a link above the title of the listing. The link has the text “Add to trip planner”, wherein activation of the link sends the address/serial number of the listing to the list of the destinations of the user. The system, besides capturing the address from the link, can also receive additional information, such as timings during which the site is open for visitors.

In one aspect, the system can receive the destinations or addresses of the destination from the user. The system can provide an interface having a form, wherein the user can enter the address. The system can parse the address, and search the location associated with the address. Thereafter, the system through the interface can show the location to the user, wherein the user can either confirm the location or select another.

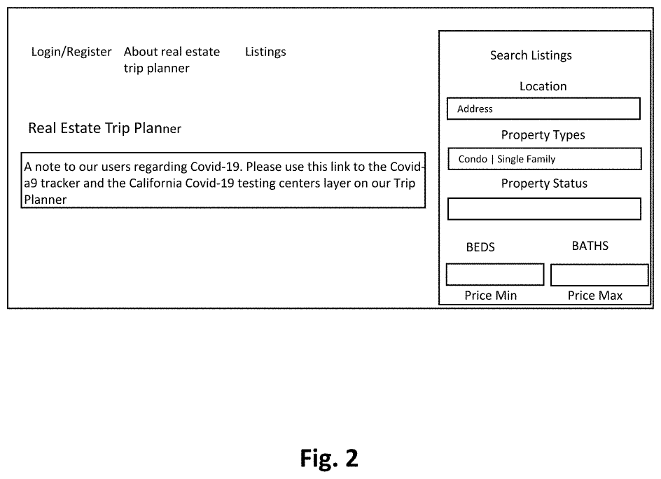

In one aspect, the disclosed system can also provide a search interface to the user, wherein the search interface may allow a user to search the desired destination. For example, a search interface for real estate listings can be provided that allows a user to search for real estate listings. FIG. 2 shows an exemplary embodiment of the search interface for real estate listings. The search interface provides a form having options, such as location, property types, property status, beds, baths, price range, and like. The user can search for one or more options. The results of the search can be shown on a different interface wherein the interface has the option to select one or more listings, which can then be received by the system for making the travel plan.

In one aspect, the disclosed system can provide an interface to receive images from a user device. The user device can be a smartphone, laptop, desktop, workstation, iPad, tablet computer, and like. The user device can include a camera for capturing images. Alternatively, the images which have been captured through another device can be downloaded to the user device. The user device can also include network circuitry for connecting to the disclosed system through a network. The network can be wired or wireless. Wired networks may include Digital Subscriber Line (DSL), coaxial cable lines, or optical fiber lines. The wireless networks may include BLUETOOTH, Wi-Fi, Worldwide Interoperability for Microwave Access (WiMAX), an infrared channel or satellite band, cellular networks such as 2G, 3G, 4G, or 5G.

The interface on the user device can be provided as application software. In one case, the application software can be downloaded from an application distribution platform, such as App Store, Google Play, Chrome Webstore, and Amazon Appstore. Alternatively, the interface can also be provided through world-wide-web and accessible on the user's device through a web browser, such as Chrome. Also, the plugin, extension, software engines, and like provided by the system can be incorporated in the application software or the web browser.

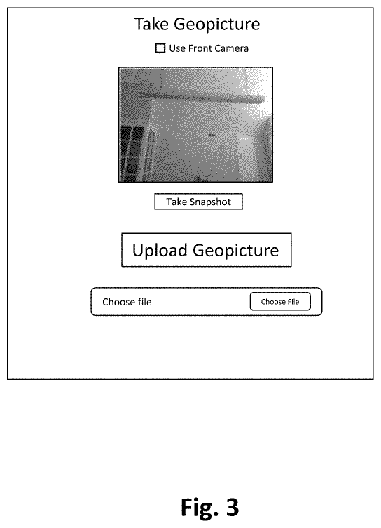

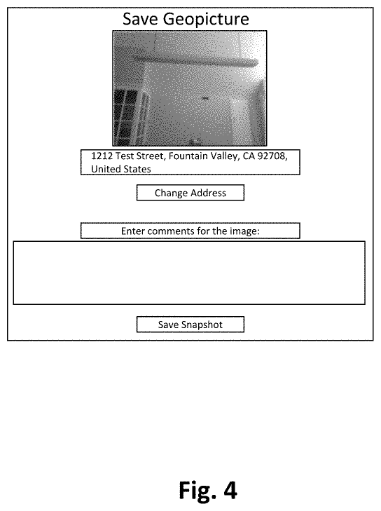

A user can upload an image through the interface, as shown in FIG. 3, using a file system of the user device. The interface can retrieve the location coordinates from the metadata of the image. The interface can upload the location coordinate to the system which can then retrieve the exact geographical address of the location coordinates. The geographical location/address can then be displayed on the interface, as shown in FIG. 4. The interface can provide an option to change the address. Alternatively, the system can receive the image and retrieve the geographical address to determine the location. The location can then be added to the list of the destinations the user desire to visit.

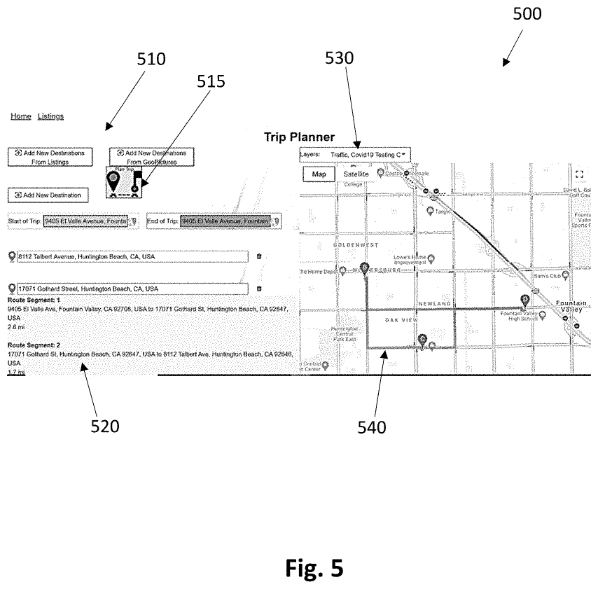

The travel route plan can be superimposed on a map, preferably a dynamic map. The functions of the dynamic map can include turn-by-turn navigation, traffic, medical facilities, fuel stations, road closures, hazards, natural calamities, eateries, and like. The different facilities and places of interest can also be provided as a layer on the dynamic map. The map interface can provide an option to select one or more layers and hide other layers on the dynamic map. For example, a drop-down menu can be provided with the label of the layers. The label can be such as traffic, covid-19 testing facilities, restaurants, and like. The user on the map interface can select one or more of the layers. FIG. 5 shows a main interface 500, provided by the system, and presented on the user device. Interface 500 is having three options 510 to add a new destination i.e., add new destinations from the listings, add new destinations from images, and manually add the destinations. A clickable button 515 can be activated by the user for determining the optimum travel plan. Area 520 on interface 500 shows route segments between the starting point and first destination, and between the subsequent destinations. On the right side of the interface can be seen the travel plan superimposed on a map interface 540. The map interface can also be presented in a separate window. The map interface also having a drop-down menu 530 that permits a user to select one or more layers and hide the other.

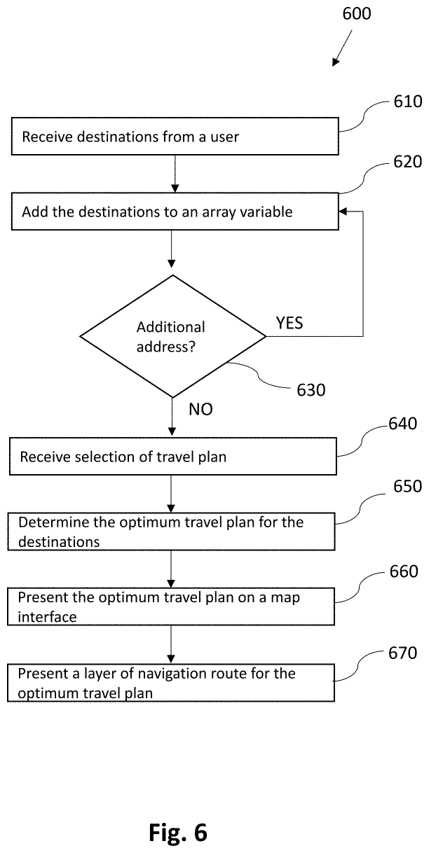

In one embodiment, disclosed is a method for generating a travel plan for subsequent destinations. FIG. 6 shows a flow chart 600 illustrating an exemplary embodiment of the method for generating an optimum travel plan for several travel destinations. At step 610, the system can receive a destination from a user. The destination can be added in the form of addresses, GPS coordinates, or like method known in the art for identifying a location. The destinations can also be added through a search interface, capturing directly from a webpage, uploading an image having location coordinates, and like methods. The system, upon receiving the address, can add it to an array variable, referred to herein as the destination array, at step 620. The system can check if any additional address is received, at step 630. In case, the additional address is received by the system, it can be added to the destination array. If all the addresses have been provided by the user, the user can click the option to determine the optimum travel plan, at step 640. For example, a clickable button can be provided on an interface. The button can have text, such as “Plan Trip”. The system can then determine the optimum travel plan based on the predetermined range of factors, at step 650. The system can then present the destinations on a map interface, at step 660. For example, the destinations can be presented as icons on the map. The travel plan including the navigation route can then be superimposed on the map interface, at step 670. The map interface includes the dynamic map for navigation and other information.

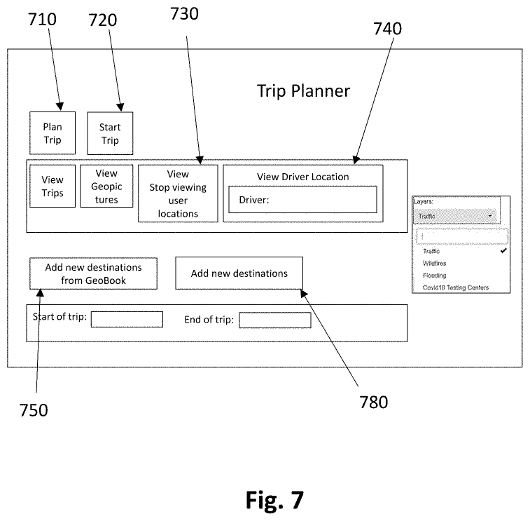

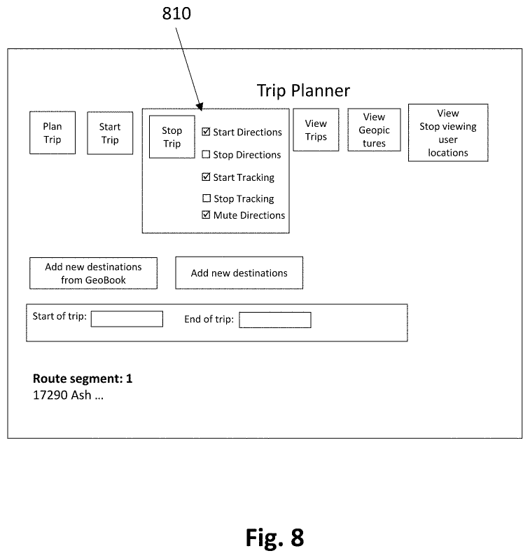

Referring to FIG. 7 shows another interface of the disclosed trip planner. Different options can be provided as soft buttons, wherein option 710 can be selected to plan the trip. Adjacent option 720 can be for starting the trip, wherein a user can start a preprogrammed trip. The interface shown in FIG. 7 can permit a user to view tracking information of other users, wherein the tracking information can be the near real-time locations of the user, destinations, and paths taken by the user. The interface can provide an option to view the user location and to stop viewing the locations using the soft button 730. Option 740 can allow the user to select a user/driver of whom the tracking information wishes to be viewed. Option 750 and option 780 can provide for adding the destinations. The interfaces, geotracking, and geolocation mechanisms shown in FIG. 7 and FIG. 8 can be client side and can be provided through an application software or a web browser. Features such as location tracking and geolocation can be available in the user device on which the interface can be implemented.

A user can have an option to track a trip including the destinations and path taken by the user. Location coordinates with date and time can be captured by the system as the tracking information. A user can share live tracking information with other users in near real-time and the user can view the tracking information of the other users in near real-time. The interface can provide an option to start and stop tracking. FIG. 8 shows option 810 that may allow a user to start or stop tracking. The system can also provide an option to limit the users that can view live tracking information of a user. The system can designate administrators who can see live tracking information of all the users including the locations and paths in real-time as they traverse on their journeys. Option 810 may also allow a user to start and stop directions. The “start directions” options may allow users to hear step-by-step directions to a destination, including real-time changes and time in traffic.

In one exemplary embodiment, users' trips can be shown on a map in near real-time, along with their current locations (shown on a map as a bouncing icon), their real-time Estimated Time of Arrivals (ETA), and destinations. The ETA can be updated in near real-time, accounting for the changing traffic conditions and stops. Such as map can be a dynamic map, wherein the tracking information can be displayed as layers overlayed on a dynamic map. The user can choose what to view in the tracking information, including destination and a live icon showing the current location of the user being tracked.

In one exemplary embodiment, the system may allow users to save their trips including the tracking information. The saved trips can be later viewed by the user or the trips can also be shared with other users. Such trip tracking information can be queried based on the date and destinations, such as a user can search for saved trip tracking data. The user can also incorporate images in the tracking information as geo-pictures, wherein the geo-pictures can be presented on the map. The geo-pictures can be displayed as an icon wherein hovering on the icon or clicking on the icon causes the picture to be displayed.

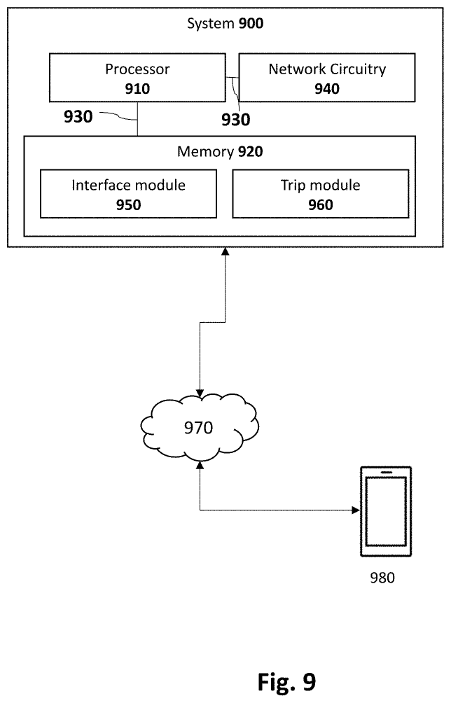

Referring to FIG. 9 which is an environmental diagram showing the system 900 having a processor 910, a memory 920, and a network circuitry 940 all connected through a system bus 930. The system can be connected to a user device 980, also referred to herein as the client device, through a network 970. The user device can include functionality like global position system for tracking and geo-positioning. The memory 920 can include modules, such as interface module 950 and trip module 960. The interface module upon execution by the processor can provide an interface on the user device 980, such as shown in FIG. 7. The trip module 960 upon execution by the processor can provide for trip planning as illustrated in FIG. 6.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for providing an optimum travel plan for a plurality of subsequent destinations, the method comprising the steps of:
receiving, by a system, a plurality of destinations from one or more interfaces provided by the system;
adding, by the system, the plurality of destinations in a destination array;
determining, by the system, an optimum travel plan for the plurality of destinations based on predefined factors;
presenting, by the system, on a map interface, the optimum travel plan superimposed on a dynamic map;
capturing, by the system, tracking information of the optimum travel plan, wherein the tracking information includes location coordinates stamped with date and time; and
permitting, by the system, sharing of the tracking information.

2. The method according to claim 1, wherein at least one interface of the one or more interfaces is configured to capture an address or a location from a webpage or listing.

3. The method according to claim 2, wherein the listing or webpage is a real estate listing, and the address or location is of the real estate property.

4. The method according to claim 2, wherein the at least one interface is configured to:
find addresses or locations on a webpage; and
provide an option to capture one or more of the addresses or locations.

5. The method according to claim 1, wherein at least one interface of the one or more interfaces is configured to receive an image from a user device, the image has location coordinates of where the image was captured, wherein the system is configured to retrieve a destination of the plurality of destinations from the location coordinates.

6. The method according to claim 1, wherein at least one predetermined factor of the predetermined factors is shortest travel distance.

7. The method according to claim 6, wherein at least one predetermined factor of the predetermined factors is least travel time.

8. The method according to claim 6, wherein the method further comprises the steps of:
receiving an appointment time for at least one destination of the plurality of destinations, wherein at least one predetermined factor of the predetermined factors is the appointment time.

9. The method according to claim 8, wherein the appointment time is received through an interface presented on a user device.

10. The method according to claim 8, wherein at least one interface of the one or more interfaces is configured to capture an address or a location from a webpage or listing, the at least one interface is also configured to receive visiting hours of the address or a location, wherein at least one predetermined factor of the predetermined factors is the visiting hours.

11. The method according to claim 1, wherein the dynamic map is configured to display turn-by-turn navigation route for the optimum travel plan.

12. The method according to claim 11, wherein the dynamic map is configured to display traffic in near real-time on the navigation route.

13. The method according to claim 11, wherein the dynamic map is configured to display covid-19 testing facilities.

14. The method according to claim 1, wherein the dynamic map includes a plurality of layers superimposed over each other, each layer presenting a distinct functionality of the dynamic map, the map interface includes an option to select one or more of the plurality of layers and hide the other.

15. The method according to claim 14, wherein one layer of the plurality of layers is having the functionality of displaying covid-19 testing facilities.

16. The method according to claim 15, wherein one layer of the plurality of layers is having the functionality of displaying traffic in a navigation route for the optimum travel plan.

17. The method according to claim 1, wherein the tracking information is shared in near real time.
